(19) United States
(12) Patent Application Publication
(10) Pub. No.: US 2005/0062564 A1
(43) Pub. Date: Mar. 24, 2005

(54) Alarm output device for circuit breaker

(76) Inventors: Yoshinobu Hamada, Saitama (JP); Takeshi Emura, Saitama (JP); Katsunori Kuboyama, Saitama (JP)

Correspondence Address: HAUPTMAN KANESAKA BERNER;Patent Agents, LLP, Suite 310, 1700 Diagonal Road, Alexandria, VA, 22314, US

(21) Appl. No.: 10/925,956

(22) Filed: Aug. 26, 2004

(30) Foreign Application Priority Data
Sep. 4, 2003 (JP) 2003-313034

(51) Int. Cl. H01H 73/12

(52) U.S. Cl. 335/17; 340/639; 200/18

(57) ABSTRACT

An alarm output device is capable of outputting a mechanical alarm signal to attached alarm switches in linkage with a tripping operation of a circuit breaker. The alarm output device includes an alarm output plate provided on an outer lateral surface of a frame of an opening/closing mechanical unit and is operable in linkage with a latch of the opening/closing mechanical unit, so that a movement of the alarm output plate is transmitted to the attached alarm switches to perform a switching operation. The alarm output plate is provided with a pair of operation terminal members corresponding to an internal alarm switch and an external alarm switch of the circuit breaker.

### BACKGROUND OF THE INVENTION AND RELATED ART STATEMENT

The present invention relates to an alarm output device for a circuit breaker, and more particularly, relates to an alarm output device for outputting a mechanical alarm signal to an alarm switch attached to a circuit breaker in linkage with a tripping operation of the circuit breaker.

As well known, a circuit breaker is provided with an alarm switch for detecting a tripping operation of the circuit breaker and outputting an electrical signal as an optional attachment, in addition to an auxiliary switch for detecting an ON/OFF status of the circuit breaker and outputting an electrical signal to an external device. Japanese Patent Publication (Kokai) No. 2001-52589 has disclosed a circuit breaker provided with an alarm output device. In the circuit breaker, an alarm output plate corresponding to an alarm switch (optional attachment) is provided on an outer surface of a frame of an opening/closing mechanical unit and is operable in linkage with a latch of the opening/closing mechanical unit (upon detection of over-current), so that a movement of the alarm output plate is transmitted to the alarm switch for switching the alarm switch.

Japanese Patent Publication (Kokai) No. 2001-297680 has disclosed a modification of the alarm output plate disclosed in Japanese Patent Publication (Kokai) No. 2001-52589. In Japanese Patent Publication (Kokai) No. 2001-297680, operation terminal members projecting from a alarm output plate are arranged so as to correspond to a plurality of storage sections formed in a case of a circuit breaker for storing subordinate units, so that a user can select a type and storage section of an internally disposed switch. Further, Japanese Patent Publication (Kokai) No. 2001-297681 has disclosed another modification of the alarm output plate disclosed in the Japanese Patent Publication (Kokai) No. 2001-52589, in which operation terminal members of a alarm output plate are disposed on both ends of a alarm output plate so as to correspond to external switches attached to both sides of a case of a circuit breaker.

In Japanese Patent Publications (Kokai) No. 2001-52589, No. 2001-297680 and No. 2001-52589, each of the alarm output plates is supported and guided to slide along an external surface of a frame of an opening/closing mechanical unit in a vertical direction, and is urged upwardly with a drive spring. Normally, the alarm output plate is held at a lower position. When the circuit breaker is tripped upon detecting over-current, a latch of the opening/closing mechanical unit moves. In linkage with the movement of the latch, the alarm output plate slides in a lateral direction to be disengaged. While the alarm output plate is lifted upwardly due to the force of the drive spring, the attached alarm switch is switched via the projecting operation terminal members.

The conventional sliding type alarm output plates have various technical problems as follows. It is necessary to assemble many parts in many steps, including a guide mechanism for guiding and holding the alarm output plate, a mechanism for holding the alarm output plate at a predetermined position, and the drive spring. It is also necessary to provide a space for the alarm output plate to slide, thereby increasing external dimensions of the circuit breaker. Further, in view of operational stability and reliability, the conventional sliding type alarm output plates tend to suffer from sliding friction, wear on component parts, and unstable movement. The alarm output plate may be disengaged inadvertently due to external vibration and shock, thereby potentially causing malfunction of the attached alarm switch.

The circuit breakers generally have different specifications with respect to the main spring of the opening/closing mechanical unit, an inter-phase insulating distance, and the external dimensions of the case for storing the circuit breaker depending on a rated voltage and current. Accordingly, when the conventional sliding type alarm output plate is used, it is necessary to separately design and produce the alarm output plate and the opening/closing mechanical unit provided with the alarm output plate according to a different frame of the circuit breaker, thereby complicating management of component parts.

As described above, as the optional attachments of the conventional circuit breakers, the internally attached switch is attached to the storage section formed in the case for storing the circuit breaker, and the externally attached switch is attached to the external surface of the case thereof. Accordingly, it is necessary to provide the alarm output plate in the circuit breaker for both the internal alarm switch and the external alarm switch, so that a user can select a type of switch. However, it is difficult to use the conventional sliding type alarm output plate without making the structure and shape more complex.

In view of the problems described above, the present invention has been made, and an object of the present invention is to provide an alarm output device with a simple structure and a simple supporting member for both an internal alarm switch and an external alarm switch attached to a circuit breaker.

Further objects and advantages of the invention will be apparent from the following description of the invention.

### SUMMARY OF THE INVENTION

In order to achieve the objects described above, according to the present invention, an alarm output device is capable of outputting a mechanical alarm signal to an attached alarm switch in linkage with a tripping operation of a circuit breaker. The alarm output device includes an alarm output plate provided-on an outer lateral surface of a frame of an opening/closing mechanical unit and is operable in linkage with a latch of the opening/closing mechanical unit, so that a movement of the alarm output plate is transmitted to the attached alarm switch to perform a switching operation. According to a first aspect of the present invention, the alarm output plate performs a swing movement operation (swing type), and is provided with a pair of operation terminal members corresponding to an internal alarm switch and an external alarm switch of the circuit breaker.

According to a second aspect of the present invention, the alarm output plate includes a swinging plate provided with forked leg members extending toward the internal alarm switch and the external alarm switch with a vertex thereof as a fulcrum. The fulcrum is pivotally supported on the opening/closing mechanical unit, and a portion eccentrically offset from the fulcrum is directly connected to a toggle shaft of the latch linked with the tripping operation of the opening/closing mechanical unit. A pair of operation terminal members corresponding to the internal alarm switch and the external alarm switch is respectively formed at tips of the forked leg members.

According to a third aspect of the present invention, the alarm output plate is detachably fixed to the opening/closing mechanical unit, thereby making assembly of the circuit breaker simple.

In the alarm output device of the invention, it is possible to transmit the mechanical alarm signal upon tripping to both the internal and external alarm switches of the circuit breaker with the single alarm output plate disposed in the opening/closing mechanical unit. Accordingly, it is easy for a user of the circuit breaker to select between the internal switch and the external switch.

Further, as compared with the conventional sliding type alarm output plates, the swing type alarm output plate of the present invention can be assembled simply through engagement with a part of the opening/closing mechanical unit without a complex guide mechanism, complex engaging mechanism, and drive spring. In view of functionality and reliability, it is possible to reduce wear and wobble of the alarm output plate caused by sliding abrasion, thereby obtaining stable performance and higher reliability for a long period of time.

### BRIEF DESCRIPTION OF THE DRAWINGS

FIGS. 1(a) to 1(c) are schematic views showing a circuit breaker and an alarm output device according to an embodiment of the present invention, wherein FIG. 1(a) is a front view of an opening/closing mechanical unit and an alarm output plate, FIG. 1(b) is a front view of the circuit breaker provided with an assembly unit formed of the opening/closing mechanical unit and the alarm output plate, and FIG. 1(c) is a plan view of the circuit breaker provided with internal and external alarm switches;

FIGS. 2(a) and 2(b) are explanatory views for explaining an operation of the circuit breaker shown in FIGS. 1(a) to 1(c), wherein FIG. 2(a) is a view showing an operation of the opening/closing mechanical unit while the circuit breaker is ON, and FIG. 2(b) is a view showing an operation of the alarm output plate while the circuit breaker is ON;

FIGS. 3(a) and 3(b) are explanatory view for explaining a tripping operation of the circuit breaker corresponding to the state shown in FIGS. 2(a) and 2(b), wherein FIG. 3(a) is a view showing an operation of the opening/closing mechanical unit, and FIG. 3(b) is a view showing an operation of the alarm output plate; and

FIGS. 4(a) and 4(b) are views showing a circuit breaker and an alarm output plate according to another embodiment of the present invention, wherein FIG. 4(a) is a front view of the alarm output plate, and FIG. 4(b) is a front view of the circuit breaker provided with an assembly unit formed of the alarm output plate shown in FIG. 4(a) and an opening/closing mechanical unit.

### DETAILED DESCRIPTION OF PREFERRED EMBODIMENTS

Hereunder, embodiments of the present invention will be explained with reference to the accompanying drawings. In an alarm output device of the present invention, an alarm output plate is disposed in an opening/closing mechanical unit of a circuit breaker, and is operable in response to a tripping operation of the opening/closing mechanical unit. The alarm output plate outputs a mechanical alarm signal to an internal alarm switch and an external alarm switch attached to the circuit breaker, respectively.

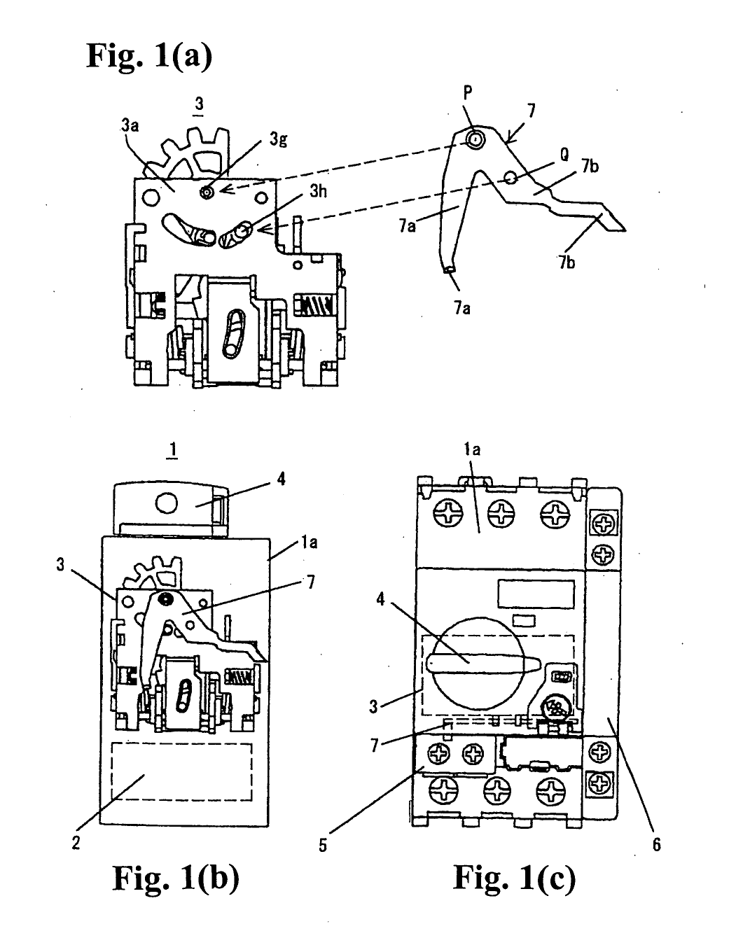

In FIGS. 1(a) to 1(c), reference numeral 1 designates a circuit breaker, reference numeral 1a designates a case for storing the circuit breaker 1, reference numeral 2 designates a current breaker, reference numeral 3 designates an opening/closing mechanical unit for opening and closing a main-circuit contact, reference numeral 4 designates an operating handle (rotary handle), reference numeral 5 designates an internal alarm switch disposed inside the case 1a of the circuit breaker 1, reference numeral 6 designates an external alarm switch attached to an outer surface of the case 1a, and reference numeral 7 designates an alarm output plate integrated with an assembly frame 3a of the opening/closing mechanical unit 3. Although not shown, an over-current detection unit is built into the circuit breaker 1.

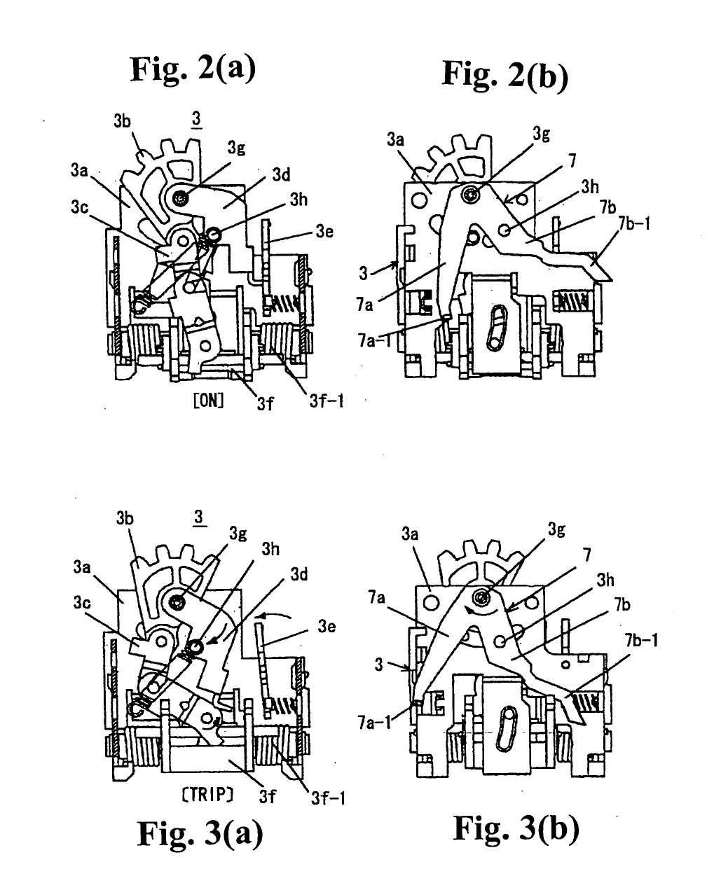

As shown in FIGS. 2(a) and 3(a), the opening/closing mechanical unit 3 includes the following components disposed in the assembly frame 3a: a follower gear 3b engaging a drive gear of the operating handle 4 (refer to FIG. 1(b)); a toggle link 3c; a latch unit 3d; a latch receiver 3e for holding the latch unit 3d at a locked position and releasing the latch unit 3d from a held state upon receipt of a signal from an over-current detection unit (not shown); an opening/closing lever 3f for driving a movable contact (not shown) of the current breaker unit 2 (refer to FIG. 1(b)) between ON and OFF positions; and a drive spring 3f-1 for driving the opening/closing lever 3f. The latch unit 3d associated with the tripping operation of the circuit breaker includes a lever having one end axially supported on an axis identical to that of a supporting shaft 3g of the follower gear 3b and the other end engaging the latch receiver 3e. A central portion of the latch unit 3d is linked to the toggle link 3c via a U-shaped toggle shaft 3h.

An operation of the opening/closing mechanical unit 3 will be briefly described next. FIG. 2(a) is a view of the opening/closing mechanical unit 3 in an ON state, whereas FIG. 3(a) is a view of the opening/closing mechanical unit 3 in the tripping operation. When the over-current detection unit of the circuit breaker detects over-current in a main circuit and the latch unit 3d is released from the held state, the latch unit 3d of the opening/closing mechanism unit 3 urged by the spring 3f-1 moves clockwise around the supporting shaft 3g as shown in FIG. 3(a). The toggle link 3c linked with the latch unit 3d via the U-shaped toggle shaft 3h following the clockwise rotation thereof bends into a bent shape shown in FIG. 3(a), so that an opening/closing lever 3f is released from the held state. As a result, the opening/closing lever 3f is rotated by the force of the drive spring 3f-1, and opens the main-circuit contact of the current breaker unit 2 (refer to FIG. 1(b)), thereby shutting off the current.

The alarm output plate 7 shown in FIGS. 1(a) to 1(c) and a fixing structure of the alarm output plate 7 on the opening/closing mechanical unit 3 will be described next. As shown in FIG. 1(a), the alarm output plate 7 is a forked member formed in an inverse V-shape and having a pair of leg members 7a and 7b extending to the left and right directions with a shaft hole P formed at a vertex portion thereof as a swinging fulcrum. A pair of operation terminal members 7a-1 and 7b-1 corresponds to the internal alarm switch 5 and the external alarm switch 6 of the circuit breaker 1, and is formed at tips of the forked leg members 7a and 7b.

The alarm output plate 7 swings about the supporting shaft 3g. An operating lever (not shown) of the external alarm switch 6 is arranged on a moving path of the operation terminal member 7b-1, so that the operation terminal member 7b-1 of the alarm output plate 7 operates the operating lever of the external alarm switch 6 when the alarm output plate 7 swings. With this arrangement, the single alarm output plate 7 can operate the internal and external alarm switches 5 and 6 of the circuit breaker 1. In addition, a shaft hole Q is formed at a position eccentrically offset from the shaft hole P. The shaft holes P and Q coaxially correspond to the supporting shaft 3g and the toggle shaft 3h of the opening/closing mechanical unit 3 shown in FIGS. 2(a) and 3(a).

When the alarm output plate 7 is assembled to the opening/closing mechanical unit 3, the alarm output plate 7 is aligned along an outer surface of the assembly frame 3a, and the supporting shaft 3g and the toggle shaft 3h of the opening-and-closing mechanical unit 3 are fitted into the shaft holes P and Q to detachably engage. FIG. 1(b) is a view showing a state that the alarm output plate 7 is assembled to the opening-and-closing mechanical unit 3 of the circuit breaker 1. The operation terminal members 7a-1 and 7b-1 at the tips of the forked leg members 7a and 7b individually correspond to operating tip portions of the internal alarm switch 5 and the external alarm switch 6 attached to the circuit breaker 1.

In the above constitution, when the circuit breaker 1 is ON (refer to FIG. 2(a)), the alarm output plate 7 is retracted to a standby position shown in FIG. 2(b). When the circuit breaker 1 is switched OFF by operating the handle 4, the latch unit 3d remains at the held position shown in FIG. 2(a), and the alarm output plate 7 remains at the position shown in FIG. 2(b).

When the circuit breaker 1 is tripped upon detection of over-current in the main circuit under the above condition, in linkage with the clockwise rotation of the latch unit 3d shown in FIG. 3(a), the alarm output plate 7 swings about the supporting shaft 3g in the clockwise direction in conjunction with the toggle shaft 3h from a position shown in FIG. 2(a), and then moves to a position shown in FIG. 3(b). When the alarm output plate 7 swings, the operation terminal member 7a-1 of the left-side leg member 7a contacts the internal alarm switch 5 attached to the inner portion of the case 1a of the circuit breaker 1 to turn ON, so that the alarm switch 5 outputs an electrical alarm signal indicating the tripping.

At the same time, as shown in FIG. 1(c), the other operation terminal member 7b-1 of the right-side leg member 7b contacts the external alarm switch 6 attached to a right side surface of the case of the circuit breaker 1 to turn ON, so that the alarm switch 6 outputs an electrical alarm signal. Although not shown, the external alarm switch 6 is further provided with an operating lever projecting into the moving path of the operation terminal member 7b-1 of the alarm output plate 7 through an opening formed in a lateral surface of the case of the circuit breaker 1. Accordingly, when the circuit breaker 1 is tripped, the operation terminal member 7b-1 of the alarm output plate 7 pushes the operating lever to turn the external alarm switch 6 ON, thereby externally outputting the electrical alarm signal.

As described above, in the embodiment, the single alarm output plate 7 outputs the mechanical alarm signal to the internal alarm switch 5 and the external alarm switch 6 attached to the circuit breaker 1. The alarm output plate 7 has a simple configuration, and thus can be easily integrated with the opening-and-closing mechanical unit 3.

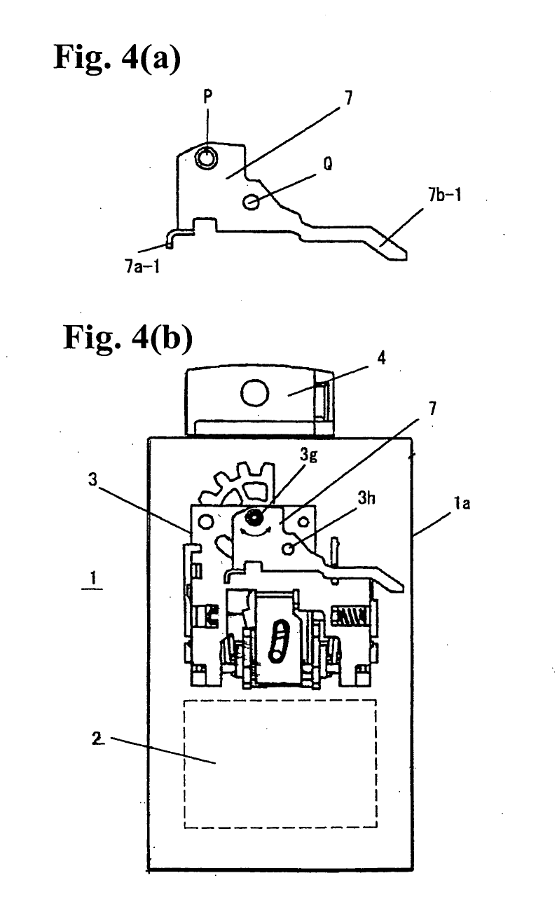

As shown in FIGS. 4(a) and 4(b), an alarm output plate according to another embodiment of the present invention is applied to a circuit breaker with a different rated voltage and current. The circuit breaker according to the second embodiment has a specific rated capacity and external dimension greater than those of the circuit breaker 1 according to the first embodiment. According to the greater rated capacity and external dimensions of the circuit breaker, the alarm output plate 7 has a modified forked shape and modified operation terminal members 7a-1 and 7b-1 shown in FIG. 4(a). The alarm output plate 7 is assembled to the opening/closing mechanical unit 3 in the same way as the first embodiment.

As described above, according to the present invention, the alarm output plate 7 can be detachably assembled to the opening/closing mechanical unit 3, and may be formed in various shapes. Therefore, when the alarm output plate 7 is attached to a circuit breaker with a different rated capacity and different external dimension, the alarm output plate 7 cab be attached to a common opening/closing mechanical unit for different circuit breakers simply by changing the shape thereof, so that the internal alarm switch and the external alarm switch attached to the circuit breaker can be shared.

The disclosure of Japanese Patent Application No. 2003-313034 filed on Sep. 4, 2003 has been incorporated in the application.

While the invention has been explained with reference to the specific embodiments of the invention, the explanation is illustrative and the invention is limited only by the amended claims.

1. An alarm output device for outputting a mechanical alarm signal to alarm switches disposed inside and outside of a circuit breaker in a tripping operation of the circuit breaker, comprising:
an opening/closing mechanical unit having a frame and a latch, and
an alarm output plate provided on an outer surface of the frame and operationally linked with the latch so that a movement of the alarm output plate is transmitted to the alarm switches, said alarm output plate having a pair of operation terminal members corresponding to the alarm switches.

2. An alarm output device according to claim 1, wherein said alarm output plate includes a swinging plate having leg members extending toward the alarm switches, and a vertex between the leg members, said swinging plate swinging about the vertex and pivotally supported on the opening/closing mechanical unit, said alarm output plate being connected to a toggle shaft linked with the latch of the opening/closing mechanical unit at a position offset from the vertex, said leg members having operation terminals at tip portions thereof.

3. An alarm output device according to claim 1, wherein said alarm output plate is detachably attached to the opening/closing mechanical unit.
